(19) United States
(12) Patent Application Publication
(10) Pub. No.: US 2009/0020944 A1
(43) Pub. Date: Jan. 22, 2009

(54) PRINTING MACHINE AND DELIVERY OF PRINTING MACHINE

(75) Inventors: Takahiko Ide, Tokyo (JP); Akira Otani, Tokyo (JP); Yoshio Ueda, Tokyo (JP); Yasuhiko Hirata, Tokyo (JP)

Correspondence Address: LOWE HAUPTMAN HAM & BERNER, LLP, 1700 DIAGONAL ROAD, SUITE 300, ALEXANDRIA, VA, 22314, US

(73) Assignee: MITSUBISHI HEAVY INDUSTRIES, LTD, TOKYO (JP)

(21) Appl. No.: 12/278,565

(22) PCT Filed: Feb. 20, 2007
(86) PCT No.: PCT/JP2007/053053

§ 371 Date: Aug. 6, 2008

(30) Foreign Application Priority Data
Feb. 23, 2006 (JP) 2006-047116

(51) Int. Cl. B41F 33/00

(52) U.S. Cl. 271/207

(57) ABSTRACT

It is an object of the present invention to secure safety of a human body accessible to a side of a delivery conveyor during operations of a printing machine. Each of sensors 79 in an area sensor that form a sensing area B to prevent access of a human body to the side of a delivery conveyor (a chain gripper or the like) is arranged on the side of the delivery conveyor of a delivery unit in a paper ejector 7. Sensing operations of some of the sensors 79 in the area sensor are controlled to be turned off by a control device 9 in conjunction with a preset instruction of presetting a size of sheet and operations of the printing machine to sense access of a human body to the side of the delivery conveyor and prevent a sheet from being sensed by the sensors 79 during printing operations.

### RELATED APPLICATIONS

The present application is based on International Application No. PCT/JP2007/053053, filed Feb. 20, 2007, which claims priority from, Japan Application Number 2006-047116, filed Feb. 23, 2006, the disclosures of which are hereby incorporated by reference herein in their entirety.

### TECHNICAL FIELD

The present invention relates to a printing machine that has a delivery unit in which printed sheets that are conveyed and discharged by a delivery conveyor are accommodated and a delivery of the printing machine, and particularly to a printing machine in which safety of an operator is secured in the delivery unit and a delivery of the printing machine.

### BACKGROUND ART

A printing machine such as an offset printing machine includes a delivery unit that accommodates sheets to which printing is performed in multiple colors by a plurality of printing units and that are conveyed and discharged by a delivery conveyor. The delivery conveyor conveys printed sheets by holding them by a rotating chain gripper and discharges them at a predetermined position of the delivery unit. The discharged sheets are stacked and accommodated at the delivery unit.

In the case of the printing machine, an operator needs, for example, to approach a delivery unit and pick up a sheet to be examined or take out piled sheets during printing. In these operations, a head, body, hand, or arm of the operator enters into the delivery unit, so that it may touch a dangerous part such as a chain gripper therein via an opened portion of the delivery unit. Therefore, to avoid such a risk, as Patent Document 1 discloses, conventionally, an area sensor for monitoring is arranged at the periphery of a delivery unit. When the area sensor senses that an operator approaches the delivery unit, a printing machine is automatically stopped.

Patent Document 1: Germany Patent No. 10310236

### DISCLOSURE OF INVENTION

### Problem to be Solved by the Invention

However, an operation performed together with extending a hand near a chain gripper during printing of sheets is needed in the printing machine. Therefore, an area sensor needs to be turned off in advance. An operation button or a pilot lamp to turn off the area sensor needs to be installed or an automatic reset function after a predetermined time, for example 20 seconds, needs to be added. Furthermore, it may be impossible to secure safety in the printing machine while the area sensor is turned off.

In view of the above description, it is an object of the present invention to provide a printing machine and a delivery of the printing machine by which it is possible to secure safety of a human body accessible to the printing machine during its operation.

### Means for Solving Problem

According to an aspect of the present invention, a paper ejector of a printing machine includes a paper ejection unit in which a pile of printed sheets conveyed and discharged by a delivery conveyor is accommodated. The paper ejector comprises: an area sensor that includes a plurality of sensors arranged between the delivery conveyor and a top surface of a pile of sheets, each of the sensors provides a sensing area to sense access of a human body to a side of the delivery conveyor; and a sensor controlling unit that controls sensing operations performed by some of the sensors of the area sensor to be turned off in conjunction with a preset instruction of presetting a size of the sheet and operations of the printing machine.

According to the above invention, a sensing area is formed by each of sensors that constitute an area sensor to sense access of a human body to a side of a delivery conveyor. A sensor controlling unit controls some sensors of the area sensor to turn off their sensing operations in conjunction with an instruction of presetting a size of sheet and operations of the printing machine. Therefore, it is possible to secure safety of a human body accessible to the printing machine during its operation. Moreover, sensors arranged in a range of a size of sheet are turned off based on each size of sheet during printing to prevent the sensors from sensing a sheet during printing of the printing machine and to make it possible for a human body to get access to a delivery unit except the sensing area.

In the paper ejector of the printing machine, the area sensor may emit light beams in the sensing area in a direction in which a sheet is conveyed by the delivery conveyor and forms the sensing area to sense access of a human body to the side of the delivery conveyor.

According to the above invention, the area sensor emits light beams in a direction in which a sheet is conveyed with respect to a sheet conveyed by the delivery conveyor to form the sensing area. Therefore, when the sensor controlling unit controls a state of each sensor in the area sensor, sensors that are to be turned off are changed for control into sensors arranged in a range of a size of sheet based on an arrangement pitch among sensors and a size of sheet. This makes it possible to prevent sensing a sheet by the sensors during printing of the printing machine and for a human body to get access to the delivery unit except the sensing area.

In the paper ejector of the printing machine, an arrangement pitch between sensors of the area sensor may be set to be smaller near both edges of the printed sheet than that of sensors arranged further from both edges of the printed sheet, the edges are parallel to a direction in which a sheet is conveyed.

According to the above invention, when the sensor controlling unit controls a state of each sensor in the area sensor, it is possible to sense access of a human body to the sensing area by the appropriate number of sensors based on a size of sheet.

In the paper ejector of the printing machine, the sensor controlling unit may control sensing operations of some of the sensors of the area sensor to be turned off based on a size of the printed sheets when the printing machine performs printing to the sheets, sensing operations of all the sensors of the area sensor to be turned off when the printing machine stops operating, and sensing operations of all the sensors of the area sensor to be turned on in operations except the printing operation or the non-printing operation.

According to the above invention, when printing, sensing operations of the sensors that constitute the area sensor based on a size of sheet are turned off, so that it is possible to sense access of a human body to the sensing area by the appropriate number of sensors based on a size of sheet. When stopping printing, sensing operations of all the sensors are turned off because of a low possibility of making a human body in a state of being dangerous. In operations of the printing machine except the above operations, because a possibility that a human body may be made in a state of being dangerous with no sheet placed in the delivery unit is high, sensing operations of all the sensors are turned on. This makes it possible for the area sensor to cover the entire sensing area and to easily sense access of a human body to a side of the delivery conveyor.

In the paper ejector of the printing machine, the sensor controlling unit may control sensing operations of the sensors to sense access of a human body in a range of a size of the printed sheets to be turned off when the printing machine performs printing to the sheets.

According to the above invention, sensing operations of the sensors arranged in a range of a size of sheet are turned off, so that only access of a human body to the side of the delivery conveyor is sensed by the sensors during operations of the printing machine without sensing a sheet.

According to another aspect of the present invention, a printing machine includes a paper ejector in which sheets conveyed by a delivery conveyor are discharged through an opened portion and the discharged sheets are accommodated. The printing machine comprises: an area sensor that includes a plurality of sensors arranged between the delivery conveyor and a top surface of the accommodated sheets and that forms a sensing area to sense access of a human body to a side of the delivery conveyor near an end of the opened portion that extends in a direction intersecting with a longitudinal direction of a sheet that is passed through the opened portion, and a sensor controlling unit that performs on/off control, based on preset information about a size of sheet received by the printing machine, to the sensors arranged near the end of the opened portion through which largest size of sheets are passed but sheets that are reduced in width in a longitudinal direction compared with the largest size of sheets are not passed in the sensing area, when discharged.

According to the above invention, each of the sensors that constitute the area sensor forms the sensing area to sense access of a human body to the side of the delivery conveyor. The sensing area that is changed based on a size of sheet appropriately corresponds to an area near an edge of an opened portion through which a sheet is passed.

### EFFECT OF THE INVENTION

A sensor controlling unit in a delivery of a printing machine of the present invention changes and controls sensing operations of each of sensors in an area sensor in conjunction with a size of sheet and operations of the printing machine, so that it is possible to effectively secure safety of a human body when the human body gets access to the printing machine during operations of the printing machine because access of the human body is sensed in a sensing area that is dangerous for a human body without the sensors sensing a sheet during printing.

### BRIEF DESCRIPTION OF DRAWINGS

FIG. 1 is a schematic diagram of an offset printing machine as an example.

FIG. 2 is a schematic side view of a delivery according to an embodiment of the present invention.

FIG. 3 is a schematic perspective view of the delivery according to the embodiment of the present invention.

FIG. 4 is a schematic block diagram of a circuit to sense access of a human body to a sensing area.

FIG. 5 is a top view of a delivery unit when a delivery conveyor in the delivery is omitted.

FIG. 6 is a flowchart for explaining a monitoring operation in the delivery.

### EXPLANATIONS OF LETTERS OR NUMERALS

1 printing machine
2, 3, 4, 5 printing unit
6 feeder
7 paper ejector
8 protection cover
9 control device
10 input/output device
11 sensor controller
12 sensing-signal detecting unit
13 informing device
51 blanket cylinder
52 impression cylinder
71 discharging cylinder
72 chain guide
73 chain
74 chain gripper
75 stopper
76 sheet below guiding unit
77 paper ejection unit
78 containing member
79 sensor
80 side frame
81 opened portion
82 vacuum vehicle
91 processor
92 storing unit
B sensing area
K, K1, K2 sheet
P pile of sheets

### BEST MODE(S) FOR CARRYING OUT THE INVENTION

The present invention is explained in detail below with reference to drawings. The present invention is not limited by an embodiment. The embodiment includes components some of which those in the art can easily consider or some of which are actually the same. An offset printing machine is explained in the following embodiment. The printing machine according to the present invention is not limited to an offset printing machine. Any printing machine can be used that includes at least a chain gripper for conveying and discharging sheets printed by printing units to a delivery unit and the delivery unit for accommodating discharged sheets.

### Embodiment

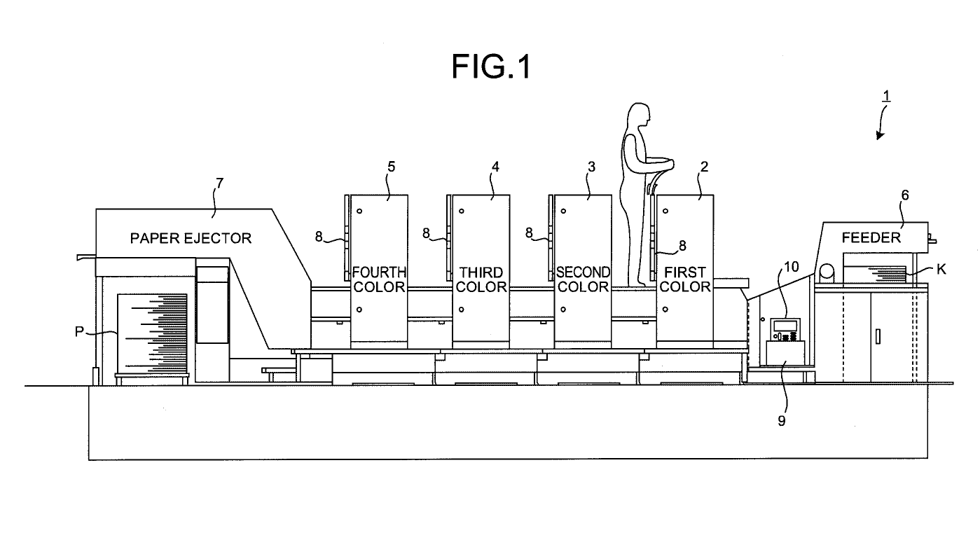

FIG. 1 is a schematic diagram of an offset printing machine as an example. As shown in FIG. 1, the offset printing machine 1 includes a plurality of printing units, which are four printing units 2, 3, 4, and 5 in the embodiment, a feeder 6, a paper ejector 7, and a control device 9 that drives and controls the offset printing machine 1. A middle cylinder (not shown) is arranged among the printing units 2 to 5. Reference number 10 denotes an input/output device such as an operating panel by which an instruction is input by an operator when the printing machine is driven and on which a state in which the printing machine is operated is indicated to an operator.

Each of the printing units 2 to 5 includes therein an ink supplying unit, a dampening-water supplying unit, a group of rollers needed for printing such as a plate cylinder, a blanket cylinder, and an impression cylinder, a cylinder rotating unit, and a cylinder attaching/detaching unit. These units and the rollers are covered by a protection cover 8. Each of the printing units 2 to 5 according to the embodiment uses ink of a different color. For example, Chinese ink is used in the first printing unit 2, indigo-blue ink in the second printing unit 3, red ink in the third printing unit 4, and yellow ink in the fourth printing unit 5. Ink is supplied from the ink supplying unit. An ink film made of the ink that is formed along a printing area on a printing plate surface and that is transferred to the blanket cylinder is transferred to a sheet K held by each of the impression cylinders, so that information of the printing plate is printed to the sheet K color by color.

Ink is supplied from the ink supplying unit and damping water is supplied from the dampening-water supplying unit in each of the printing units 2 to 5. An ink film formed along a printing area on a printing plate surface and transferred to the blanket cylinder is transferred to a sheet K held by each impression cylinder, so that information on the printing plate is printed to the sheet K color by color. The control device 9 controls cylinder synchronizing rotation in the cylinder rotating unit and attaching/detaching a cylinder in the cylinder attaching/detaching unit.

As shown in FIG. 1, the feeder 6 is arranged in front of the printing unit 2 to supply sheets K to be printed to the printing machine 1. The paper ejector 7 is arranged behind the printing unit 5 to discharge the sheets K that are passed through the printing units 2 to 5 out of the printing machine 1. The feeder 6 and the paper ejector 7 are driven and controlled by the control device 9. The sheets K fed from the feeder 6 to the printing machine 1 are sequentially passed through the printing units 2 to 5. Information of each printing plate is printed color by color in the printing units 2 to 5. The sheets K are conveyed by the blanket cylinder 51 and the impression cylinder 52 of the printing unit 5 to the paper ejector 7.

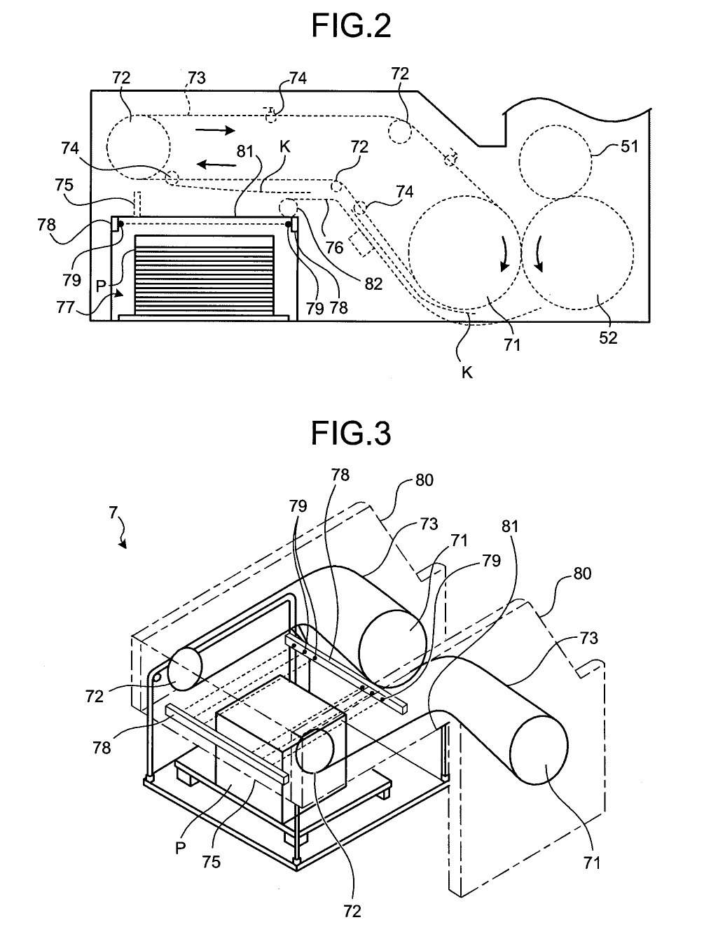

FIG. 2 is a schematic side view of the paper ejector 7. FIG. 3 is a schematic perspective view of the delivery. As shown in FIGS. 2 and 3, the paper ejector 7 includes a discharging cylinder 71 that conveys the printed sheets K that have been passed between the blanket cylinder 51 and the impression cylinder 52, a plurality of chain guides 72 arranged in a pair of side frames 80, a chain 73 that is rotated through the chain guides 72 in a direction indicated by an arrow in the drawing, a chain gripper 74 that are attached to the chain 73, 73 to receive and hold the above-described conveyed sheet K, a stopper 75 by which the conveyed sheet K is stopped, a sheet below guiding unit 76 that is arranged below a path on which the chain gripper 74 is moved, a paper ejection unit 77 that accommodates a pile of sheets P that consist of the discharged sheets K, a containing member 78 in which sensors are contained and arranged, a plurality of sensors 79 that are arranged in the containing member 78 to constitute an area sensor, and a vacuum vehicle 82 that reduces speed at which sheets K are conveyed on the sheet below guiding unit 76.

A sheet K that is passed between the blanket cylinder 51 and the impression cylinder 52 is caught by the chain gripper 74 at a position of the discharging cylinder 71. Under this state, the sheet K is guided by the sheet below guiding unit 76 and is conveyed in a direction in which a pile of sheets P is accommodated. The sheet K that is conveyed by the chain gripper 74 is stopped by the vacuum vehicle 82, is detached from the chain gripper 74 at a position of the stopper 75, and is sequentially stacked on the pile of sheets P. The discharging cylinder 71, the chain guides 72, the chain 73, and the chain gripper 74 constitute a delivery conveyor of the present invention.

The chain gripper 74 includes a chain gripper shaft both ends of which are supported by the chain 73, 73, claw seats arranged at a plurality of positions in an axial direction of the chain gripper shaft, a claw shaft supported by a shaft fixing jig in parallel with the chain gripper shaft, a claw on the claw shaft that is fixed opposite to the claw seat, and a spring (not shown) to urge the claw in a direction of the claw seat. Thus, a printed sheet K is caught by the claw and the claw seat.

Two containing members 78 constitute a pair and two sensors 79 arranged at the containing members 78, 78 also constitute a pair. The containing members 78, 78 of the paper ejection unit 77 are arranged to face each other on a side of the delivery conveyor, that is, between the delivery conveyor and a top surface of the pile of sheets, more specifically, in such a manner that light paths of light beams from each pair of sensors 79, 79 conform to each other at the opened portion 81 to pass sheets from the delivery conveyor to the paper ejection unit 77 between the vacuum vehicle 82 arranged below the delivery conveyor and a top surface of the pile P of sheets. This opposite arrangement of the containing members 78 makes it possible to emit light beams as if the light beams cover the edge of the opened portion 81 that extends in a direction in which a sheet is conveyed.

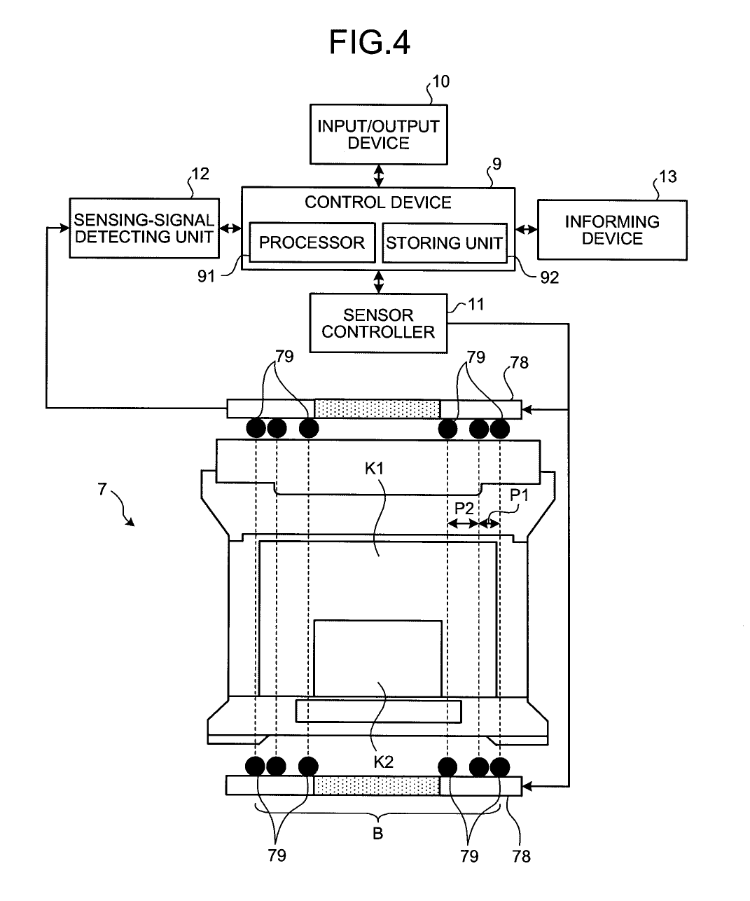

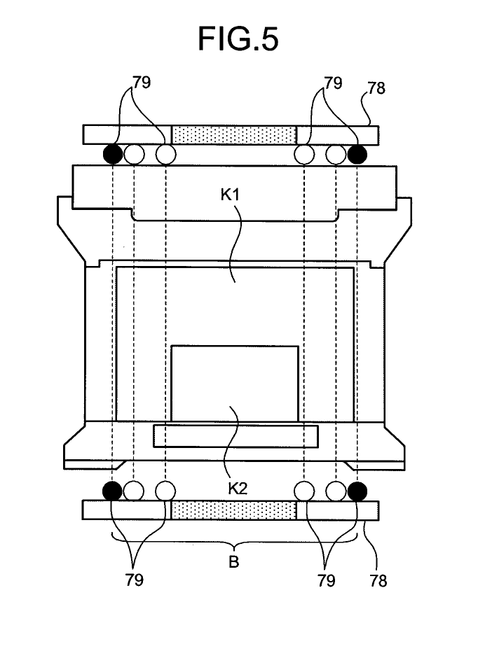

The sensors 79 that constitute the area sensor according to the present invention is explained with reference to FIGS. 4 and 5. FIG. 4 is a schematic block diagram of a circuit to sense access of a human body to a sensing area B. FIG. 5 is a top view for explaining a top surface of the delivery unit when the delivery conveyor of the paper ejector 7 is omitted. Reference symbol K1 in the drawing denotes a largest size of sheet and reference symbol K2 denotes a smallest size of sheet. In FIG. 5, a top surface of the paper ejection unit 77 when the delivery conveyor of the paper ejector 7 is omitted is indicated. Each of the sensors 79 is arranged in a direction in which a sheet K is conveyed by the delivery conveyor. As shown in the drawing, according to the embodiment, the plurality of sensors is arranged to emit a light beam in the same direction as the direction of conveying a sheet. For example, a light emitting sensor is arranged at one containing member 78 and a light receiving sensor is arranged at the other containing member 78 that is opposite to the light emitting sensor in such a manner that a light path of the light receiving sensor is consistent with a light path of the light emitting sensor. An edge area of the opened portion 81 in a direction in which a sheet is conveyed is sensed, and access of a human body to the sensing area B is sensed (see FIG. 4) by taking it as a determining criterion that the counterpart light receiving sensor cannot detect a light beam from the light emitting sensor.

The sheets K1 and K2 are exemplified in the embodiment. More particularly, a beam line from the sensors 79 is set to cover an area through which an edge of the largest size of sheet K1 is passed and, when a sheet reduced in width in its longitudinal direction compared with the large-sized sheet, such as a sheet K2, is printed, an edge of the sheet K2 is not passed, near an opened end that extends in a direction intersecting with the longitudinal direction of a sheet that is passed through the opened portion 81 through which different-sized sheets are discharged when taking a conveying direction as a criterion. This makes it possible to properly set a size of a sensing area to sense access of a human body to the side of the delivery conveyor in response to a change of width in the longitudinal direction of a sheet.

Specifically, on/off control is performed to the sensors arranged near the end of the opened portion 81 through which the largest size of sheet is passed and, when a sheet reduced in width in the longitudinal direction compared with the largest size of sheet is discharged, the sheet reduced in width in the longitudinal direction is not passed, in response to preset information about a size of sheet that the printing machine receives, though later-described in detail. Therefore, it is possible to automatically support a change in a width direction of a sheet.

The sensors 79 are arranged at irregular spaces, for example, based on a size of sheet K used for printing. In this case, as shown in FIG. 4, an arrangement pitch P1 between the sensors 79 arranged on the containing member 78 is set to be smaller near both edges of a sheet with a different size, that is, both edges (an edge of a sheet in a direction intersecting with the longitudinal direction of a sheet K1) of a sheet in parallel with a direction in which the largest size of sheet K1 is conveyed in this embodiment. In addition, other arrangement pitch P2 between the sensors arranged in a range of a difference between the sheets K1 and K2 is set to be larger. According to the embodiment, when printing is performed to smallest size of sheets K2, sensing operations of all the sensors 79 are turned on (indicated as in FIG. 4). When printing is performed to largest size of sheets K1, sensing operations of only the outermost sensors 79 are turned on (indicated as in FIG. 5). Therefore, it is possible to sense only access of a human body to the sensing area B without sensing a sheet conveyed by the delivery conveyor.

According to the present invention, it is possible to sense access of a human body to the sensing area B, instead of the light emitting sensor and the light receiving sensor, for example, by arranging a plurality of reflective beam sensors on one containing member 78 and a reflective plate on the other containing member 78 and receiving reflected beams from light emitting units of the beam sensors at a light receiving unit. Alternatively, an arrangement pitch among sensors can be set to be small (for example, a pitch of about 15 millimeters) at equal spaces to easily detect a hand of an operator or the like. Furthermore, the sensors 79 can be set to sense access of a human body to the sensing area B only when some of the sensors 79 cannot detect a beam.

The control device 9 that controls driving of the printing machine 1 includes a processor 91 and a storing unit 92. The processor 91 performs synchronous rotation control and attachment/detachment control with respect to an ink-side roller, a dampening-water-side roller, and the plate cylinder. The storing unit 92 stores therein programs to determine contents of controlling each device. The control device 9 also performs driving control and informing control with respect to the area sensor 79. The circuit shown in FIG. 4 includes the control device 9, the input/output device 10, a sensor controller 11, a sensing-signal detecting unit 12, and an informing device 13.

A preset instruction of presetting a size of sheet through operation of an operator is received from the input/output device 10. Sheet-size information based on the preset information is sent to the sensor controller 11 by the processor 91 of the control device 9. The sensor controller 11 specifies the sensors 79 that perform sensing operations based on the sheet-size information and actuates only the specified sensors 79. In other words, as described above, when smallest size of sheets K2 are printed, sensing operations of all the sensors 79 are turned on. When largest size of sheets K1 are printed, sensing operations of only the outermost sensors 79 are turned on. The processor 91 monitors driving of the printing machine 1.

Operations of driving the printing machine 1 include, for example, performing printing to sheets, stopping printing, loose (idling) driving without printing, inching, and the like. A plurality of operations is performed in the paper ejector 7 by an operator during each of the driving operations. Operations during performing printing to sheets among the operations have an extremely small risk, for example, a human body being involved in the chain gripper 74 because a human body cannot approach to the side of the delivery conveyor in the paper ejection unit 77 in view of arrangement of the containing member 78 according to the present invention and a pile of sheets P accommodated in the paper ejection unit 77. Furthermore, when the printing machine stops driving, the delivery conveyor also stops driving, so that it is natural that a risk associated with operations is extremely small. However, the delivery conveyor is rotated while a pile of sheets are not accommodated in the paper ejection unit 77 during loose or inching driving. Therefore, a human body can approach to the side of the delivery conveyor in the paper ejection unit 77, so that a risk associated with operations is increased.

Access of a human body to the sensing area B is monitored by the processor 91 according to the embodiment by turning off sensing operations of all the sensors 79 in the area sensor while the printing machine 1 performs printing to sheets K and stops performing printing to sheets K, and turning on sensing operations of the sensors 79 specified in response to a size of sheet during printing of the printing machine 1. Alternatively, access of a human body to the sensing area B is monitored by turning on sensing operations of all the sensors 79 in the area sensor during driving the printing machine 1 (such as loose or inching operations) except stopping driving the printing machine 1. On/off control with respect to sensing operations of the sensors 79 can be performed, for example, by controlling power supply to the area sensor 79 by the sensor controller 11 and powering on/off with respect to each of the sensors 79. Alternatively, sensing operations of the area sensor 79 can be set to be turned on/off by the processor 91 turning on/off a detecting signal from the sensing-signal detecting unit 12.

The sensing-signal detecting unit 12 detects a sensing signal output from the area sensor 79. According to the embodiment, the light-emitting sensor and the light-receiving sensor are used to detect a sensing signal output by sensing a light beam in the light-receiving sensor, so that the detected result is sent to the control device 9. The informing device 13 that includes a warning light or a buzzer arranged in the paper ejection unit 77, for example, informs of access of a human body to the sensing area B that is a dangerous area by turning on/off the warning light or setting off the buzzer based on control of the processor 91. Thus, before an accident that, for example, a body of an operator may be actually involved in the chain gripper 74 occurs, the potential risk can be informed to an operator. The processor 91 stops driving the printing machine 1 or performs a display to inform of being dangerous to a display portion (not shown) in the input/output device 10 with respect to access of a human body to the sensing area B. Thus, it is possible to inform operators except operators working associated with the paper ejector 7 of the potential risk.

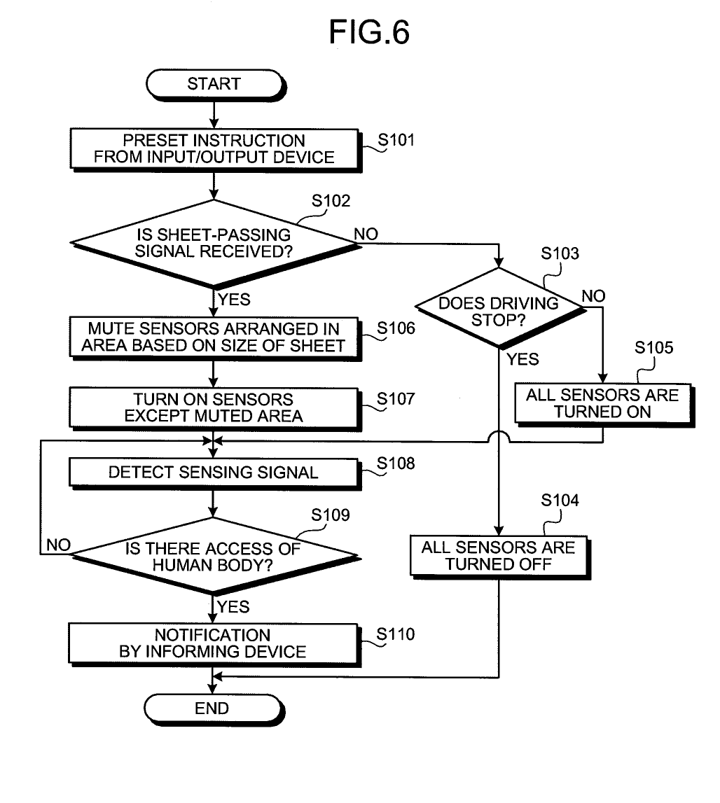

Next, an operation of monitoring the delivery is explained by using a flowchart in FIG. 6. First, when a preset instruction of presetting a size of sheet is sent from the input/output device 10 (at step S101), the processor 91 determines whether a sheet-passing signal is received from the input/output device 10 (at step S102). The processor 91 determines whether, when the sheet-passing signal is not received, the printing machine 1 stops driving (at step S103). This determination is performed based on an instruction of a driving operation from the input/output device 10. When the printing machine 1 is at a stop, because the delivery conveyor does not convey sheets, the processor 91 controls the sensor controller 11 to set sensing operations of all of the sensors 79 to be turned off (muting) (at step S104). When the printing machine 1 drives except when the printing machine 1 stops driving, sensing operations of all of the sensors 79 are turned on (at step S105) and a sensing signal is detected by the sensing-signal detecting unit 12 (at step S108).

When a sheet-passing signal is received at step S102, the delivery conveyor conveys sheets. Thus, the sensor controller 11 shown in FIG. 4 mutes predetermined sensors 79 based on an instruction of a size of sheet that is controlled by the processor 91. In other words, according to the embodiment, when printing is performed to largest size of sheets K1, the sensors 79 except outermost sensors 79 are muted. When printing is performed to smallest size of sheets K2, sensing operations of all the sensors 79 are turned on (at steps S106 and S107).

Next, the sensing-signal detecting unit 12 detects a sensing signal from each of the sensors 79 and outputs the detected results to the processor 91 (at step S108). The processor 91 determines whether a human body gets access to a sensing area based on the detected result from the sensing-signal detecting unit 12. When a human body does not get access to the sensing area, a sensing signal is detected at step S108. When a human body gets access to the sensing area, the processor 91 controls operations of the informing device 13, which gives a warning by using the warning light, the buzzer, or the like (at step S110).

Thus, according to the embodiment, each of sensors that constitute an area sensor forms a sensing area to sense access of a human body to a side of a delivery conveyor, and sensing operations performed by some of the sensors in the area sensor are controlled to be turned off in conjunction with an instruction of presetting a size of sheet and operations of a printing machine. Therefore, it is possible to get access to a delivery unit during operations of the printing machine and secure safety of a human body that gets access to the delivery unit during operations of the printing machine.

Furthermore, according to the embodiment, it is possible to change a muted area in the sensing area by turning off the sensors arranged within a range of each size of sheet based on a size of sheet during printing. Therefore, a sheet conveyed by the delivery conveyor can be passed through the muted area. Consequently, a human body can get access to an area of the delivery unit except the sensing area without the sensors sensing a sheet during printing operations of the printing machine.

Moreover, according to the embodiment, the area sensor is constituted of the minimum number of sensors that are pairs of a light emitting sensor and a light receiving sensor to sense access of a human body to the sensing area. Therefore, it is possible to easily arrange the area sensor in the delivery unit. It is also possible to reduce load during operations because it is unnecessary for an operator to turn off the area sensor in advance and perform operations. In addition, a button for turning off the area sensor is not required to arrange, which leads to lower component count and simplification of a circuit.

Furthermore, according to the embodiment, it is possible for one area sensor to sense not only that an operator approaches the delivery conveyor but also that an operator can be present in the delivery unit (within the sensing area) during printing because the area sensor is arranged on a side of the delivery conveyor, which is dangerous, of the delivery unit and is actuated in conjunction with operations of the printing machine.

As shown in FIG. 2, the configuration that an opened portion through which a sheet caught by a chain grippers is passed when placed on the delivery unit is arranged in parallel with a surface of a sheet placed on the delivery unit is explained in the embodiment of the present invention. However, an opened portion that has a slight angle of an inclination with respect to a surface of a placed sheet may be arranged. In that case, instead of the configuration in which a light path of the sensor is parallel to a surface of a sheet, if a configuration is used in which the light path of the sensor is arranged in such a manner that the sensor emits a light beam along an edge of the opened portion that is arranged in a direction in which a sheet is conveyed based on the inclination and that the light beam is emitted to cover an area of the edge of the opened portion (an area extended in a direction in which a sheet is conveyed if a shape of the opened portion is quadrangular), the present invention can be suitably applied to the configuration.

### INDUSTRIAL APPLICABILITY

As described above, a printing machine according to the present invention is useful for a printing machine that has a delivery and, particularly suitable to secure safety of a human body accessible to the delivery during operations of the printing machine.

1. A paper ejector of a printing machine that includes a paper ejection unit in which a pile of printed sheets conveyed and discharged by a delivery conveyor is accommodated, the paper ejector comprising:
an area sensor that includes a plurality of sensors arranged between the delivery conveyor and a top surface of a pile of sheets, each of the sensors provides a sensing area to sense access of a human body to a side of the delivery conveyor; and
a sensor controlling unit that controls sensing operations performed by some of the sensors of the area sensor to be turned off in conjunction with a preset instruction of presetting a size of the sheet and operations of the printing machine.

2. The paper ejector of the printing machine according to claim 1, wherein the area sensor emits light beams in the sensing area in a direction in which a sheet is conveyed by the delivery conveyor and forms the sensing area to sense access of a human body to the side of the delivery conveyor.

3. The paper ejector of the printing machine according to claim 1, wherein an arrangement pitch between sensors of the area sensor is set to be smaller near both edges of the printed sheet than that of sensors arranged further from both edges of the printed sheet, the edges are parallel to a direction in which a sheet is conveyed.

4. The paper ejector of the printing machine according to claim 1, wherein the sensor controlling unit controls sensing operations of some of the sensors of the area sensor to be turned off based on a size of the printed sheets when the printing machine performs printing to the sheets, sensing operations of all the sensors of the area sensor to be turned off when the printing machine stops operating, and sensing operations of all the sensors of the area sensor to be turned on in operations except the printing operation or the non-printing operation.

5. The paper ejector of the printing machine according to claim 4, wherein the sensor controlling unit controls sensing operations of the sensors to sense access of a human body in a range of a size of the printed sheets to be turned off when the printing machine performs printing to the sheets.

6. A printing machine that includes a paper ejector in which sheets conveyed by a delivery conveyor are discharged through an opened portion and the discharged sheets are accommodated, the printing machine comprising:
an area sensor that includes a plurality of sensors arranged between the delivery conveyor and a top surface of the accommodated sheets and that forms a sensing area to sense access of a human body to a side of the delivery conveyor near an end of the opened portion that extends in a direction intersecting with a longitudinal direction of a sheet that is passed through the opened portion, and
a sensor controlling unit that performs on/off control, based on preset information about a size of sheet received by the printing machine, to the sensors arranged near the end of the opened portion through which largest size of sheets are passed but sheets that are reduced in width in a longitudinal direction compared with the largest size of sheets are not passed in the sensing area, when discharged.
